(19) United States
(12) Patent Application Publication
(10) Pub. No.: US 2008/0155154 A1
(43) Pub. Date: Jun. 26, 2008

(54) Method and System for Coalescing Task Completions

(76) Inventors: Yuval Kenan, Ben Shemen (IL); Merav Sicron, Kfar Sava (IL); Eliezer Aloni, Zur Yigal (IL)

Correspondence Address: MCANDREWS HELD & MALLOY, LTD, 500 WEST MADISON STREET, SUITE 3400, CHICAGO, IL, 60661, US

(21) Appl. No.: 11/962,840

(22) Filed: Dec. 21, 2007

Related U.S. Application Data
(60) Provisional application No. 60/871,271, filed on Dec. 21, 2006.
(60) Provisional application No. 60/973,633, filed on Sep. 19, 2007.

(51) Int. Cl. G06F 13/24

(52) U.S. Cl. 710/263

(57) ABSTRACT

Certain aspects of a method and system for coalescing task completions may include coalescing a plurality of completions per connection associated with an I/O request. An event may be communicated to a global event queue, and an entry may be posted to the global event queue for a particular connection based on the coalesced plurality of completions. At least one central processing unit (CPU) may be interrupted based on the coalesced plurality of completions.

### CROSS-REFERENCE TO RELATED APPLICATIONS/INCORPORATION BY REFERENCE

This application makes reference to, claims priority to, and claims benefit of U.S. Provisional Application Ser. No. 60/871,271, filed Dec. 21, 2006 and U.S. Provisional Application Ser. No. 60/973,633, filed Sep. 19, 2007.

The above stated applications are incorporated herein by reference in their entirety.

### FIELD OF THE INVENTION

Certain embodiments of the invention relate to network interfaces. More specifically, certain embodiments of the invention relate to a method and system for coalescing task completions.

### BACKGROUND OF THE INVENTION

Hardware and software may often be used to support asynchronous data transfers between two memory regions in data network connections, often on different systems. Each host system may serve as a source (initiator) system which initiates a message data transfer (message send operation) to a target system of a message passing operation (message receive operation). Examples of such a system may include host servers providing a variety of applications or services and I/O units providing storage oriented and network oriented I/O services. Requests for work, for example, data movement operations including message send/receive operations and remote direct memory access (RDMA) read/write operations may be posted to work queues associated with a given hardware adapter, the requested operation may then be performed. It may be the responsibility of the system which initiates such a request to check for its completion. In order to optimize use of limited system resources, completion queues may be provided to coalesce completion status from multiple work queues belonging to a single hardware adapter. After a request for work has been performed by system hardware, notification of a completion event may be placed on the completion queue. Completion queues may provide a single location for system hardware to check for multiple work queue completions.

Completion queues may support one or more modes of operation. In one mode of operation, when an item is placed on the completion queue, an event may be triggered to notify the requester of the completion. This may often be referred to as an interrupt-driven model. In another mode of operation, an item may be placed on the completion queue, and no event may be signaled. It may be then the responsibility of the request system to periodically check the completion queue for completed requests. This may be referred to as polling for completions.

Internet Small Computer System Interface (iSCSI) is a TCP/IP-based protocol that is utilized for establishing and managing connections between IP-based storage devices, hosts and clients. The iSCSI protocol describes a transport protocol for SCSI, which operates on top of TCP and provides a mechanism for encapsulating SCSI commands in an IP infrastructure. The iSCSI protocol is utilized for data storage systems utilizing TCP/IP infrastructure.

Large segment offload (LSO)/transmit segment offload (TSO) may be utilized to reduce the required host processing power by reducing the transmit packet processing. In this approach the host sends to the NIC, bigger transmit units than the maximum transmission unit (MTU) and the NIC cuts them to segments according to the MTU. Since part of the host processing is linear to the number of transmitted units, this reduces the required host processing power. While being efficient in reducing the transmit packet processing, LSO does not help with receive packet processing. In addition, for each single large transmit unit sent by the host, the host would receive from the far end multiple ACKs, one for each MTU-sized segment. The multiple ACKs require consumption of scarce and expensive bandwidth, thereby reducing throughput and efficiency.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for coalescing task completions, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary system illustrating an iSCSI storage area network principle of operation that may be utilized in connection with an embodiment of the invention.

FIG. 1B is an exemplary embodiment of a system for coalescing task completions, in accordance with an embodiment of the invention.

FIG. 2 is a block diagram illustrating a NIC interface that may be utilized in connection with an embodiment of the invention.

FIG. 3 is a block diagram of an exemplary system for host software concurrent processing of multiple network connections by coalescing task completions, in accordance with an embodiment of the invention.

FIG. 4 is a block diagram illustrating exemplary coalescing of task completions, in accordance with an embodiment of the invention.

FIG. 5 is a block diagram illustrating an exemplary mechanism for coalescing task completions, in accordance with an embodiment of the invention.

### DETAILED DESCRIPTION OF THE INVENTION

Certain embodiments of the invention may be found in a method and system for coalescing task completions. Aspects of the method and system may comprise coalescing a plurality of completions per connection associated with an I/O request. An event may be communicated to the global event queue, and an entry may be posted to the global event queue for a particular connection based on the coalesced plurality of completions. At least one central processing unit (CPU) may be interrupted based on the coalesced plurality of completions.

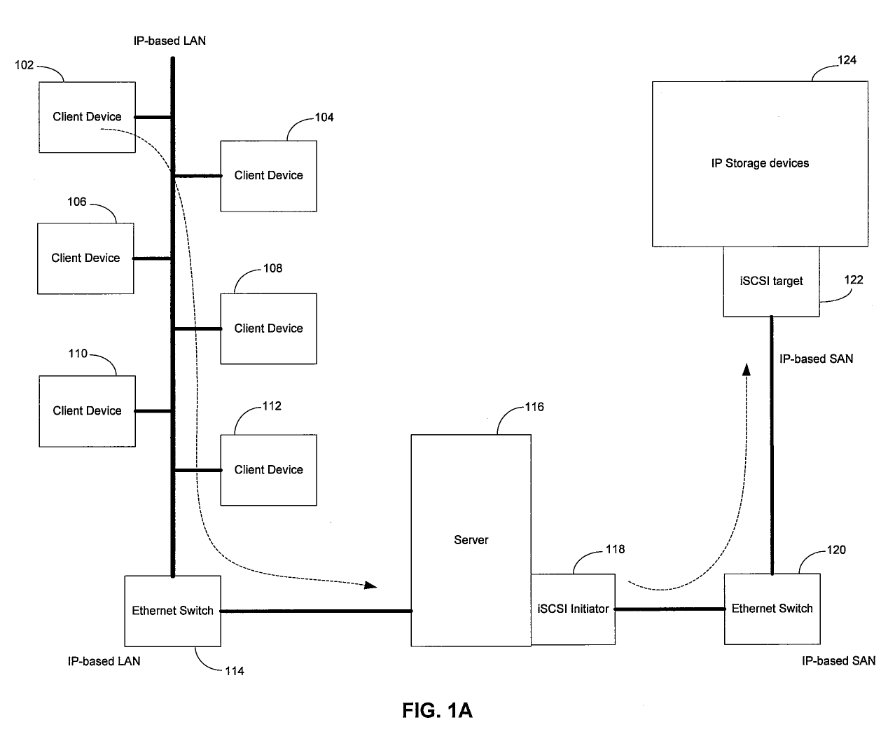

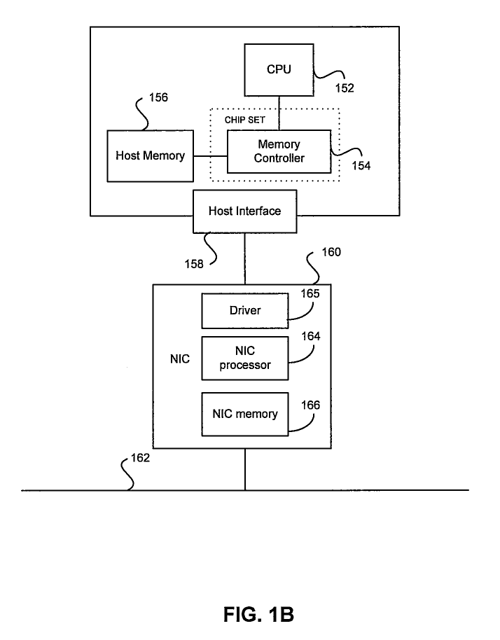

FIG. 1A is a block diagram of an exemplary system illustrating an iSCSI storage area network principle of operation that may be utilized in connection with an embodiment of the invention. Referring to FIG. 1A, there is shown a plurality of client devices 102, 104, 106, 108, 110 and 112, a plurality of Ethernet switches 114 and 120, a server 116, an iSCSI initiator 118, an iSCSI target 122 and a storage device 124.

The plurality of client devices 102, 104, 106, 108, 110 and 112 may comprise suitable logic, circuitry and/or code that may be enabled to a specific service from the server 116 and may be a part of a corporate traditional data-processing IP-based LAN, for example, to which the server 116 is coupled. The server 116 may comprise suitable logic and/or circuitry that may be coupled to an IP-based storage area network (SAN) to which IP storage device 124 may be coupled. The server 116 may process the request from a client device that may require access to specific file information from the IP storage devices 124.

The Ethernet switch 114 may comprise suitable logic and/or circuitry that may be coupled to the IP-based LAN and the server 116. The iSCSI initiator 118 may comprise suitable logic and/or circuitry that may be enabled to receive specific SCSI commands from the server 116 and encapsulate these SCSI commands inside a TCP/IP packet(s) that may be embedded into Ethernet frames and sent to the IP storage device 124 over a switched or routed SAN storage network. The Ethernet switch 120 may comprise suitable logic and/or circuitry that may be coupled to the IP-based SAN and the server 116. The iSCSI target 122 may comprise suitable logic, circuitry and/or code that may be enabled to receive an Ethernet frame, strip at least a portion of the frame, and recover the TCP/IP content. The iSCSI target 122 may also be enabled to decapsulate the TCP/IP content, obtain SCSI commands needed to retrieve the required information and forward the SCSI commands to the IP storage device 124. The IP storage device 124 may comprise a plurality of storage devices, for example, disk arrays or a tape library.

The iSCSI protocol may enable SCSI commands to be encapsulated inside TCP/IP session packets, which may be embedded into Ethernet frames for transmissions. The process may start with a request from a client device, for example, client device 102 over the LAN to the server 116 for a piece of information. The server 116 may be enabled to retrieve the necessary information to satisfy the client request from a specific storage device on the SAN. The server 116 may then issue specific SCSI commands needed to satisfy the client device 102 and may pass the commands to the locally attached iSCSI initiator 118. The iSCSI initiator 118 may encapsulate these SCSI commands inside one or more TCP/IP packets that may be embedded into Ethernet frames and sent to the storage device 124 over a switched or routed storage network.

The iSCSI target 122 may also be enabled to decapsulate the packet, and obtain the SCSI commands needed to retrieve the required information. The process may be reversed and the retrieved information may be encapsulated into TCP/IP segment form. This information may be embedded into one or more Ethernet frames and sent back to the iSCSI initiator 118 at the server 116, where it may be decapsulated and returned as data for the SCSI command that was issued by the server 116. The server may then complete the request and place the response into the IP frames for subsequent transmission over a LAN to the requesting client device 102.

In accordance with an embodiment of the invention, the iSCSI initiator 118 may be enabled to coalesce a plurality of completions associated with an iSCSI request before communicating an event to a global event queue in a particular CPU.

FIG. 1B is a block diagram of an exemplary system for coalescing task completions, in accordance with an embodiment of the invention. Referring to FIG. 1B, the system may comprise a CPU 152, a memory controller 154, a host memory 156, a host interface 158, NIC 160 and a SCSI bus 162. The NIC 160 may comprise a NIC processor 164, a driver 165, NIC memory 166, and a coalescer 168. The host interface 158 may be, for example, a peripheral component interconnect (PCI), PCI-X, PCI-Express, ISA, SCSI or other type of bus. The memory controller 156 may be coupled to the CPU 154, to the memory 156 and to the host interface 158. The host interface 158 may be coupled to the NIC 160. The NIC 160 may communicate with an external network via a wired and/or a wireless connection, for example. The wireless connection may be a wireless local area network (WLAN) connection as supported by the IEEE 802.11 standards, for example.

The NIC processor 164 may comprise suitable logic, circuitry and/or code that may enable accumulation or coalescing of completions. A plurality of completions per-connection may be coalesced or aggregated before sending an event to the event queue. An entry may be posted to the event queue (EQ) for a particular connection after receiving the particular event. A particular CPU 152 may be interrupted based on posting the entry to the event queue.

The driver 165 may be enabled to set a flag, for example, an arm flag at connection initialization and after processing the completion queue. The driver 165 may be enabled to set a flag, for example, a sequence to notify flag to indicate a particular sequence number at which it may be notified for the next iteration.

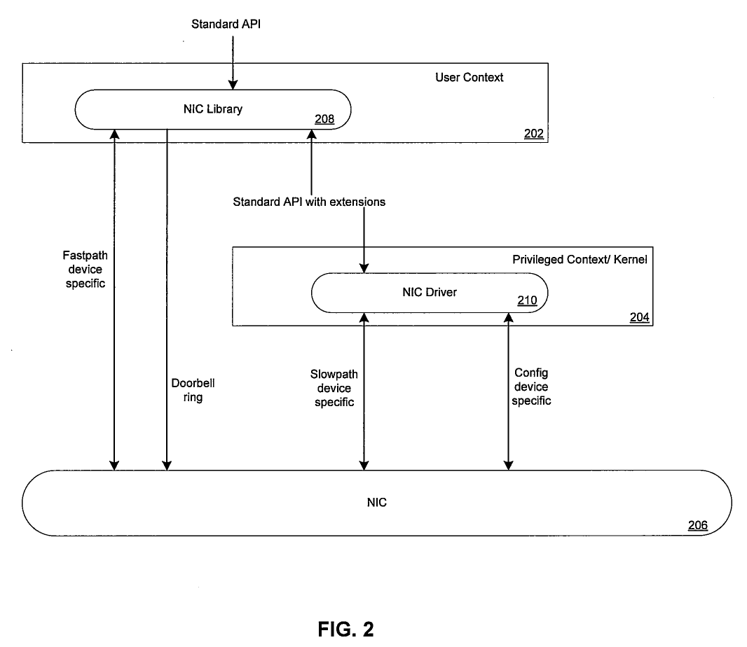

FIG. 2 is a block diagram illustrating a NIC interface that may be utilized in connection with an embodiment of the invention. Referring to FIG. 2, there is shown a user context block 202, a privileged context/kernel block 204 and a NIC 206. The user context block 202 may comprise a NIC library 208. The privileged context/kernel block 204 may comprise a NIC driver 210.

The NIC library 208 may be coupled to a standard application programming interface (API). The NIC library 208 may be coupled to the NIC 206 via a direct device specific fastpath. The NIC library 208 may be enabled to notify the NIC 206 of new data via a doorbell ring. The NIC 206 may be enabled to coalesce interrupts via an event ring.

The NIC driver 210 may be coupled to the NIC 206 via a device specific slowpath. The slowpath may comprise memory-mapped rings of commands, requests, and events, for example. The NIC driver 210 may be coupled to the NIC 206 via a device specific configuration path (config path). The config path may be utilized to bootstrap the NIC 210 and enable the slowpath.

The privileged context/kernel block 204 may be responsible for maintaining the abstractions of the operating system, such as virtual memory and processes. The NIC library 208 may comprise a set of functions through which applications may interact with the privileged context/kernel block 204. The NIC library 208 may implement at least a portion of operating system functionality that may not need privileges of kernel code. The system utilities may be enabled to perform individual specialized management tasks. For example, a system utility may be invoked to initialize and configure a certain aspect of the OS. The system utilities may also be enabled to handle a plurality of tasks such as responding to incoming network connections, accepting logon requests from terminals, or updating log files.

The privileged context/kernel block 204 may execute in the processor's privileged mode as kernel mode. A module management mechanism may allow modules to be loaded into memory and to interact with the rest of the privileged context/kernel block 204. A driver registration mechanism may allow modules to inform the rest of the privileged context/kernel block 204 that a new driver is available. A conflict resolution mechanism may allow different device drivers to reserve hardware resources and to protect those resources from accidental use by another device driver.

When a particular module is loaded into privileged context/kernel block 204, the OS may update references the module makes to kernel symbols, or entry points to corresponding locations in the privileged context/kernel block's 204 address space. A module loader utility may request the privileged context/kernel block 204 to reserve a continuous area of virtual kernel memory for the module. The privileged context/kernel block 204 may return the address of the memory allocated, and the module loader utility may use this address to relocate the module's machine code to the corresponding loading address. Another system call may pass the module and a corresponding symbol table that the new module wants to export, to the privileged context/kernel block 204. The module may be copied into the previously allocated space, and the privileged context/kernel block's 204 symbol table may be updated with the new symbols.

The privileged context kernel block 204 may maintain dynamic tables of known drivers, and may provide a set of routines to allow drivers to be added or removed from these tables. The privileged context/kernel block 204 may call a module's startup routine when that module is loaded. The privileged context/kernel block 204 may call a module's cleanup routine before that module is unloaded. The device drivers may include character devices such as printers, block devices and network interface devices.

A notification of one or more completions may be placed on at least one of the plurality of fast path completion queues per connection after completion of the I/O request. An entry may be posted to at least one global event queue based on the placement of the notification of one or more completions posted to the fast path completion queues or slow path completions per CPU.

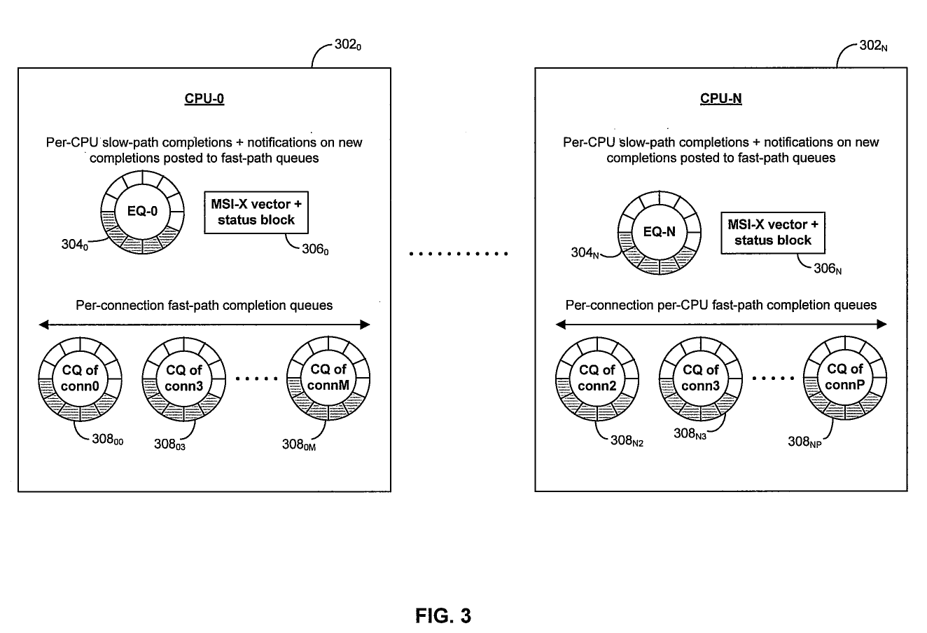

FIG. 3 is a block diagram of an exemplary system for host software concurrent processing of multiple network connections by coalescing completions, in accordance with an embodiment of the invention. Referring to FIG. 3, there is shown a plurality of interconnected central processing units (CPUs), CPU-0 302₀, CPU-1 302₁ . . . CPU-N 302_{N}. Each CPU may comprise an event queue (EQ), a MSI-X interrupt and status block, and a completion queue (CQ) for each network connection. Each CPU may be associated with a plurality of network connections, for example. For example, CPU-0 302₀ may comprise an EQ-0 304₀, a MSI-X vector and status block 306₀, and a CQ for connection-0 308₀₀, a CQ for connection-3 308₀₃ . . . , and a CQ for connection-M 308_{0M}. Similarly, CPU-N 302_{N} may comprise an EQ-N 304_{N}, a MSI-X vector and status block 306_{N}, a CQ for connection-2 308_{N2}, a CQ for connection-3 308_{N3} . . . , and a CQ for connection-P 308_{NP}.

Each event queue, for example, EQ-0 304₀, EQ-1 304₁ . . . EQ-N 304_{N} may be enabled to encapsulate asynchronous event dispatch machinery which may extract events from the queue and dispatch them. In one embodiment, the EQ, for example, EQ-0 304₀, EQ-1 304₁ . . . EQ-N 304_{N} may be enabled to dispatch or process events sequentially or in the same order as they are enqueued.

The plurality of MSI-X and status blocks for each CPU, for example, MSI-X vector and status block 306₀, 306₁ . . . 306_{N} may comprise one or more extended message signaled interrupts (MSI-X). Message signaled interrupts (MSIs) may be in-band messages that may target an address range in the host bridge unlike fixed interrupts. Since the messages are in-band, the receipt of the message may be utilized to push data associated with the interrupt. Each MSI message assigned to a device may be associated with a unique message in the CPU, for example, a MSI-X vector in the MSI-X and status block 306₀ may be associated with a unique message in the CPU-0 302₀. The PCI functions may request one or more MSI messages. In one embodiment, the host software may allocate fewer MSI messages to a function than the function requested.

Extended MSI (MSI-X) may include additional ability for a function to allocate more messages, for example, up to 2048 messages by making the address and data value used for each message independent of any other MSI-X message. The MSI-X may also allow software the ability to choose to use the same MSI address and/or data value in multiple MSI-X slots, for example, when the system allocates fewer MSI-X messages to the device than the device requested.

The MSI-X interrupts may be edge triggered since the interrupt is signaled with a posted write command by the device targeting a pre-allocated area of memory on the host bridge. However, some host bridges may have the ability to latch the acceptance of an MSI-X message and may effectively treat it as a level signaled interrupt. The MSI-X interrupts may enable writing to a segment of memory instead of asserting a given IRQ pin. Each device may have one or more unique memory locations to which MSI-X messages may be written. An advantage of the MSI interrupts is that data may be pushed along with the MSI event, allowing for greater functionality. The MSI-X interrupt mechanism may enable the system software to configure each vector with an independent message address and message data that may be specified by a table that may reside in host memory. The MSI-X mechanism may enable the device functions to support two or more vectors, which may be configured to target different CPUs to increase scalability.

Each completion queue (CQ) may be associated with a particular network connection. The plurality of completion queues associated with each connection, for example, CQ for connection-0 308₀₀, a CQ for connection-3 308₀₃ . . . , and a CQ for connection-M 308_{0M} may be provided to coalesce completion status from multiple work queues associated with a single hardware adapter, for example, a NIC 160. After a request for work has been performed by system hardware, a notification of a completion event may be placed on the completion queue, for example, CQ for connection-0 308₀₀. In one exemplary aspect of the invention, the completion queues may provide a single location for system hardware to check for multiple work queue completions.

In accordance with an embodiment of the invention, host software performance enhancement for multiple network connections may be achieved in a multi-CPU system by distributing the network connections completions between the plurality of CPUs, for example, CPU-0 302₀, CPU-1 302₁ . . . CPU-N 302_{N}. In another embodiment, an interrupt handler may be enabled to queue the plurality of events on deferred procedure calls (DPCs) of the plurality of CPUs, for example, CPU-0 302₀, CPU-1 302₁ . . . CPU-N 302_{N} to achieve host software performance enhancement for multiple network connections. The plurality of DPC completion routines of the stack may be performed for a plurality of tasks concurrently on the plurality of CPUs, for example, CPU-0 302₀, CPU-1 302₁ . . . CPU-N 302_{N}. The plurality of DPC completion routines may comprise a logical unit number (LUN) lock or a file lock, for example, but may not include a session lock or a connection lock. In another embodiment of the invention, the multiple network connections may support a plurality of LUNs and the applications may be concurrently processed on the plurality of CPUs, for example, CPU-0 302₀, CPU-1 302₁ . . . CPU-N 302_{N}.

In another embodiment of the invention, the HBA may be enabled to define a particular event queue, for example, EQ-0 304₀ to notify completions related to each network connection. In another embodiment, one or more completions that may not be associated with a specific network connection may be communicated to a particular event queue, for example, EQ-0 304₀.

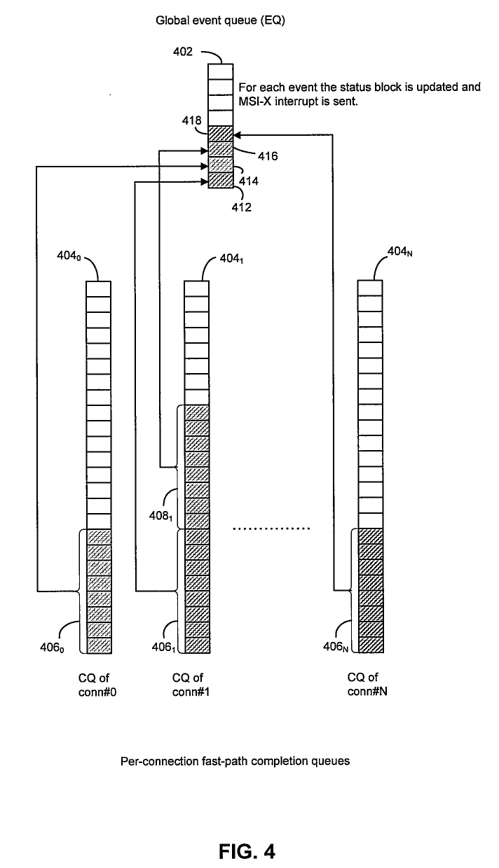

FIG. 4 is a block diagram illustrating exemplary coalescing of task completions, in accordance with an embodiment of the invention. Referring to FIG. 4, there is shown a global event queue 402, a plurality of per connection fast path completion queues, for example, a completion queue (CQ) for connection-0 404₀, a CQ for connection-1 404₁ . . . , a CQ for connection-N 404_{N}.

The CQ for connection-0 404₀ may comprise a coalesced task completion 406₀. The CQ for connection-1 404₁ may comprise a plurality of coalesced completions, for example, a coalesced task completion 406₁, and a coalesced task completion 408₁. The CQ for connection-N 404_{N} may comprise a coalesced task completion 406_{N}. The global event queue 402 may comprise a plurality of event entries, for example, 412, 414, 416, and 418.

In accordance with an embodiment of the invention, a plurality of completions may be accumulated or coalesced to generate a coalesced task completion, for example, a coalesced task completion 406₀. A plurality of completions per-connection may be coalesced or aggregated before communicating an event to the global event queue 402. An entry may be posted to the global event queue 402 for a particular connection after receiving the notification for a particular coalesced task completion. A particular CPU 152 may be interrupted based on posting the entry to the global event queue 402.

For example, a plurality of completions for connection-0 may be coalesced to generate a coalesced task completion 406₀ before communicating an event to the global event queue 402. An event entry 414 may be posted to the global event queue 402 for connection-0 after receiving the notification for the coalesced task completion 406₀. A particular CPU, for example, CPU-0 302₀ may be interrupted based on posting the entry to the global event queue 402. The status block 306₀may be updated and a MSI-X vector may be utilized to interrupt the CPU 302₀.

A plurality of completions for connection-1 may be coalesced to generate a coalesced task completion 406₁ before communicating an event to the global event queue 402. An event entry 412 may be posted to the global event queue 402 for connection-1 after receiving the notification for the coalesced task completion 406₁. A particular CPU, for example, CPU-1 302₁, may be interrupted based on posting the entry to the global event queue 402. The status block 306₁ may be updated and a MSI-X vector may be utilized to interrupt the CPU 302₁.

In another embodiment of the invention, a plurality of completions for connection-1 may be coalesced to generate a coalesced task completion 408₁ before communicating an event to the global event queue 402. An event entry 416 may be posted to the global event queue 402 for connection-1 after receiving the notification for the coalesced task completion 408₁. A particular CPU, for example, CPU-1 302₁ may be interrupted based on posting the entry to the global event queue 402. The status block 306, may be updated and a MSI-X vector may be utilized to interrupt the CPU 302₁.

In another embodiment of the invention, a plurality of completions for connection-N may be coalesced to generate a coalesced task completion 406_{N} before communicating an event to the global event queue 402. An event entry 418 may be posted to the global event queue 402 for connection-N after receiving the notification for the coalesced task completion 406_{N}. A particular CPU, for example, CPU-1 302_{N} may be interrupted based on posting the entry to the global event queue 402. The status block 306_{N} may be updated and a MSI-X vector may be utilized to interrupt the CPU 302_{N}.

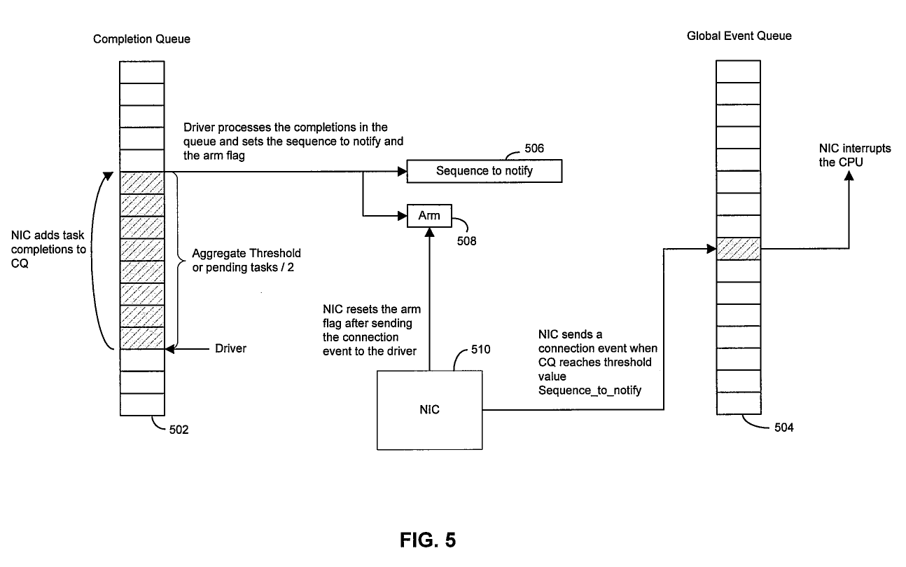

FIG. 5 is a block diagram illustrating an exemplary mechanism for coalescing task completions, in accordance with an embodiment of the invention. Referring to FIG. 5, there is shown a completion queue (CQ) 502, a global event queue (EQ) 504, a sequence to notify flag 506, an arm flag 508, and a NIC 510.

The NIC 510 may comprise suitable logic, circuitry and/or code that may enable accumulation or coalescing of completions. A plurality of completions per-connection may be coalesced or aggregated before sending an event to the EQ 504. An entry may be posted to the EQ 504 for a particular connection after receiving the particular event. The CPU 102 may be interrupted based on posting the entry to the EQ 504.

The driver 165 may be enabled to set a flag, for example, the arm flag 508 at connection initialization and after processing the CQ 502. The driver 165 may be enabled to set a flag, for example, the sequence to notify flag 506 to indicate a particular threshold value Sequence_to_notify, for example, which may indicate a sequence number at which the driver 165 may be notified for the next iteration. In accordance with an embodiment of the invention, a connection event may be communicated to the EQ in the CPU 102 when the number of completions in the CQ 502 associated with a particular connection reaches the threshold value Sequence_to_notify. The threshold value Sequence_to_notify may be the minimum between a fixed threshold value and the number of pending tasks on the particular connection divided by two. For example, the threshold value Sequence_to_notify for resetting the sequence to notify flag 506 may be represented according to the following equation:

Sequence_to_notify=MAX[1, MIN [aggregate_threshold, number of pending tasks/2]],

where the value of aggregate_threshold may be of the order of 8 completions, for example.

A timeout mechanism may be utilized to limit the time that a single completion may reside in the CQ 502 without sending a connection event to the CPU 102. When the NIC 510 adds a task completion to the CQ 502, the NIC 510 may check the arm flag 508 and the sequence to notify flag 506. If the arm flag 508 is set and the current completion sequence number is equal to or larger than the threshold value of Sequence_to_notify, the NIC 510 may communicate an event to the driver 165 for the particular connection and reset the arm flag 508. If the arm flag 508 is set, and the current completion sequence number is less than the threshold value of Sequence_to_notify, the NIC 510 may set a timer. If the timer expires before the threshold value of Sequence_to_notify is reached, a connection event may be communicated to the driver 165 for the particular connection and the arm flag 508 may be reset. The timeout value may be of the order of 1 msec, for example. In accordance with an embodiment of the invention, the sequence number may be a cyclic value and may be at least twice the size of the CQ 502, for example.

In accordance with an embodiment of the invention, the NIC 510 may add completions to the CQ 502 after the driver 165 sets the sequence to notify flag 506 but before the driver 165 may set the arm flag 508. Accordingly, the threshold value of Sequence_to_notify may be reached and the NIC 510 may communicate an event to the EQ 504.

In accordance with an embodiment of the invention, a method and system for coalescing completions may comprise a NIC 510 that enables coalescing of a plurality of completions associated with an I/O request, for example, an iSCSI request. Each completion may be, for example, an iSCSI response. At least one CPU may be associated with one or more network connections and each CPU may comprise an event queue (EQ), a MSI-X interrupt and status block, and a completion queue (CQ) for each network connection. For example, CPU-0 302₀ may comprise an EQ-0 304₀, a MSI-X vector and status block 306₀, and a CQ for connection-0 308₀₀, a CQ for connection-3 308₀₃ . . . , and a CQ for connection-M 308_{0M}. Similarly, CPU-N 302_{N} may comprise an EQ-N 304_{N}, a MSI-X vector and status block 306_{N}, a CQ for connection-2 308_{N2}, a CQ for connection-3 308_{N3} . . . , and a CQ for connection-P 308_{NP}.

The driver 165 may be enabled to set a first flag, for example, an arm flag 508 at initialization of one or more network connections. The driver 165 may be enabled to set a second flag, for example, a sequence to notify flag 506 to select a particular threshold value, Sequence_to_notify, for example, which may indicate a sequence number at which the driver 165 may be notified for the next iteration and the NIC 510 may communicate an event to the EQ 504. The first flag, for example, the arm flag 508 and the second flag, for example, the sequence to notify flag 506 may be set when a driver processes a plurality of completions in one or more completion queues. The driver may indicate to the firmware that it is ready to process more completions.

The NIC 510 may be enabled to determine whether a number of completions in one or more of the completion queues, for example, CQ 502 has reached the particular threshold value Sequence_to_notify, for example. The threshold value Sequence_to_notify may be the minimum between a fixed threshold value and the number of pending completions on the particular connection divided by two. The NIC 510 may be enabled to reset the arm flag 508 and the sequence to notify flag 506, if the determined number of completions in one or more completion queues, for example, CQ 502 has reached the particular threshold value Sequence_to_notify, for example.

The NIC 510 may be enabled to communicate an event to EQ 504 based on the coalesced plurality of completions, for example, coalesced task completion 406₀. The NIC 510 may be enabled to communicate an event to EQ 504 when the coalesced plurality of completions, for example, coalesced task completion 406₀ has reached the particular threshold value Sequence_to_notify, for example. The NIC 510 may be enabled to post an entry to EQ 504 based on the coalesced plurality of completions. The NIC 510 may be enabled to interrupt at least one CPU, for example, CPU 302₀ based on the coalesced plurality of completions, for example, coalesced task completion 406₀ via an extended message signaled interrupt (MSI-X), for example.

In accordance with another embodiment of the invention, the NIC 510 may be enabled to set a timer, if the arm flag 508 is set and the determined number of completions in one or more completion queues, for example, CQ 502 has not reached the particular threshold value Sequence_to_notify, for example. The NIC 510 may be enabled to communicate an event to EQ 504 and reset the arm flag 508, if the set timer expires before the determined number of completions in one or more completion queues, for example, CQ 502 has reached the particular threshold value Sequence_to_notify, for example.

Another embodiment of the invention may provide a machine-readable storage, having stored thereon, a computer program having at least one code section executable by a machine, thereby causing the machine to perform the steps as described above for coalescing completions.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing data, the method comprising:
coalescing a plurality of completions associated with a received I/O request; and
interrupting at least one central processing unit (CPU) based on said coalesced plurality of completions.

2. The method according to claim 1, comprising coalescing said plurality of completions per network connection.

3. The method according to claim 1, wherein said received I/O request is an iSCSI request and said completion is an iSCSI response.

4. The method according to claim 1, wherein said at least one CPU is associated with one or more network connections and each of said one or more network connections is associated with one or more completion queues.

5. The method according to claim 4, wherein said at least one CPU is associated with at least one global event queue.

6. The method according to claim 5, comprising communicating an event to said at least one global event queue when said coalesced plurality of completions has reached a particular threshold value.

7. The method according to claim 6, comprising posting an entry to said global event queue based on said coalesced plurality of completions.

8. The method according to claim 6, comprising setting a first flag at initialization of said one or more network connections.

9. The method according to claim 8, comprising setting a second flag to select said particular threshold value at which said event is communicated to said global event queue.

10. The method according to claim 9, comprising setting one or more of: said first flag and said second flag when a driver processes said plurality of completions.

11. The method according to claim 9, wherein said particular threshold value is based on a number of pending completions.

12. The method according to claim 11, comprising setting said particular threshold value to a pre-defined value when said number of pending completions is above a threshold value.

13. The method according to claim 12, comprising setting said particular threshold value to be equal to half of said number of pending completions when said number of pending completions is below said threshold value.

14. The method according to claim 9, comprising setting a timer when a determined number of said plurality of completions in said one or more completion queues has not reached said particular threshold value.

15. The method according to claim 14, comprising communicating said event to said at least one global event queue when said set timer expires before said determined number of said plurality of completions in said one or more completion queues has reached said particular threshold value.

16. A system for processing data, the system comprising:
one or more circuits that enables coalescing of a plurality of completions associated with a received I/O request; and
said one or more circuits enables interruption of at least one central processing unit (CPU) based on said coalesced plurality of completions.

17. The system according to claim 16, wherein said one or more circuits enables coalescing of said plurality of completions per network connection.

18. The system according to claim 16, wherein said received I/O request is an iSCSI request and said completion is an iSCSI response.

19. The system according to claim 16, wherein said at least one CPU is associated with one or more network connections and each of said one or more network connections is associated with one or more completion queues.

20. The system according to claim 19, wherein said at least one CPU is associated with at least one global event queue.

21. The system according to claim 20, wherein said one or more circuits enables communication of an event to said at least one global event queue when said coalesced plurality of completions has reached a particular threshold value.

22. The system according to claim 21, wherein said one or more circuits enables posting of an entry to said global event queue based on said coalesced plurality of completions.

23. The system according to claim 21, wherein said one or more circuits enables setting of a first flag at initialization of said one or more network connections.

24. The system according to claim 21, wherein said one or more circuits enables setting of a second flag to select said particular threshold value at which said event is communicated to said global event queue.

25. The system according to claim 24, wherein said one or more circuits enables setting of one or more of: said first flag and said second flag when a driver processes said plurality of completions.

26. The system according to claim 24, wherein said particular threshold value is based on a number of pending completions.

27. The system according to claim 26, wherein said one or more circuits enables setting of said particular threshold value to a pre-defined value when said number of pending completions is above a threshold value.

28. The system according to claim 27, wherein said one or more circuits enables setting of said particular threshold value to be equal to half of said number of pending completions when said number of pending completions is below said threshold value.

29. The system according to claim 24, wherein said one or more circuits enables setting of a timer when a determined number of said plurality of completions in said one or more completion queues has not reached said particular threshold value.

30. The system according to claim 29, wherein said one or more circuits enables communication of said event to said at least one global event queue when said set timer expires before said determined number of said plurality of completions in said one or more completion queues has reached said particular threshold value.
